(19) United States
(12) Patent Application Publication
(10) Pub. No.: US 2006/0038462 A1
(43) Pub. Date: Feb. 23, 2006

(54) Rotor for a generator, in particular a high-power turbogenerator

(75) Inventors: Andrew John Holmes, Baden-Daettwil (CH); Georg Stephan Klein, Wettingen (CH); John Lindh, Ehrendingen (CH); Kevin Mayor, Birmenstorf (CH); Ralf Rotzinger, Murg-Niederhof (DE)

Correspondence Address: DAVIDSON, DAVIDSON & KAPPEL, LLC, 485 SEVENTH AVENUE, 14TH FLOOR, NEW YORK, NY, 10018, US

(73) Assignee: ALSTOM Technology Ltd., Baden (CH)

(21) Appl. No.: 11/206,614

(22) Filed: Aug. 18, 2005

(30) Foreign Application Priority Data
Aug. 19, 2004 (DE) 10 2004 040 184.5

(51) Int. Cl. H02K 1/22; H02K 3/46

(52) U.S. Cl. 310/270; 310/261

(57) ABSTRACT

A rotor for a generator, in particular a high-power turbogenerator, has slots, which run axially in a rotor body and have conductor bars inserted in them, which are supported radially in the slots by means of wedges and are in each case electrically connected to one another at the ends of the rotor body in a rotor end winding. The rotor end windings are each covered by a rotor cap which is pushed over the end of the rotor body, and an electrically insulating covering channel is arranged in each of the slots between the uppermost conductor bar and the wedge and is connected outside the rotor body to a cap insulation, which is arranged between the rotor end winding and the rotor cap. The covering channels are formed with axially stepped ends at the ends of the rotor body. The cap insulation includes a ring or a plurality of cap insulation segments, which are formed toward the rotor body such that they fit onto the axially stepped ends of the covering channels, and the rotor cap is pushed directly over the cap insulation.

Priority is claimed to German Patent Application Serial No. DE 10 2004 040 184.5, filed Aug. 19, 2004, the entire disclosure of which is incorporated by reference herein.

The present invention relates to the field of electrical generators, and in particular to a rotor for a generator, in particular a high-power turbogenerator.

### BACKGROUND

A rotor such as this is known, for example, from German patent application DE 101 19 989 A1.

The major elements of a turbogenerator are a rotor which is mounted such that it can rotate about an axis (14 in FIG. 1) and is concentrically surrounded by a stator. Examples of turbogenerators such as these and of their rotors can be found in the article by K. Weigelt, “Konstruktionsmerkmale grosser Turbogeneratoren” [Design features of large turbogenerators], ABB Technik January 1989, pages 3-14. The rotor of a turbogenerator such as this has a rotor body with an enlarged diameter in the central area. One end of a rotor body such as this is illustrated in FIG. 1. Axial slots 11 are fitted on the outside of the rotor body 10 of the rotor 30 in order to hold conductor bars 12 of a rotor winding. The conductor bars 12 are fixed in the slots 11 by means of pushed-in wedges (sealing wedges) 13. Insulation 21 is provided between the uppermost conductor bar in a slot and the associated sealing wedge. The conductor bars 12 are electrically connected to one another outside the rotor body 10, forming a rotor end winding 15. The rotor end winding 15 is in general held by means of a cap ring 19, which surrounds it, against the centrifugal forces which occur during operation of the generator. The cap ring 19, together with a cap plate which is oriented at right angles (not illustrated in FIG. 1) to the axis 14 forms the rotor cap 20.

An electrically insulating layer, the so-called cap insulation 16, is fitted between the rotor end winding 15 and the cap ring 19. The cap rings 19 are normally shrunk onto the rotor body and are pushed over the cap insulation 16 in the hot state during this process. In the case of mechanically and thermally sensitive cap insulation 16, a layer of heat-resistant cap plates 17 is fitted between the cap insulation 16 and the cap ring 19. Sliding means 18 can be provided between the cap plate 17 and the cap ring 19. During operation, the cap insulation 16 has to absorb the forces which occur as a result of the centrifugal force and thermal expansion of the winding, and has to pass on these forces to the rotor cap 20.

To provide for continuous insulation of the rotor winding, the insulation 21 has to merge into the cap insulation outside the rotor body 10, in the slots 11. Until now, this transition has been provided in two different ways for rotors of different types:

The types with the first type of transition are distinguished by extremely thin winding insulation. In order nevertheless to allow high test voltages, special design precautions have been taken in order to provide sufficiently long creepage paths. The covering channels (22 in FIG. 2) which are inserted as insulation between the uppermost conductor bar and the sealing wedge at the end of the rotor body (the transition between the active part and the rotor end winding) are formed with axially stepped ends. Insulating layers 23, 24, 25, 26 composed of thin insulating material (FIG. 2) engage in the rotor end winding in the steps. The advantage of this type of transition is the thin insulation, that is to say little space is required for electromagnetically inactive material. The disadvantages of this type of transition are the poor stiffness of the cap insulation and the need for a cap plate for mechanical protection of the insulation.

The types with the other sort of transition are, instead of this, characterized by the insulation thickness being designed such that the creepage path is formed over the insulation thickness. In the case of the cap insulation, one embodiment comprises two insulation segments (half-shells) which surround the end winding and provide insulation against the rotor cap. The butt joint for insulation of the active part in the rotor body is in this case a blunt abutment. The advantages of this type of transition are the simple design, good stiffness and the fact that there is no need to use cap plate segments. The disadvantage of this type of transition is the thick insulation, that is to say more space is required for electromagnetically inactive material.

### SUMMARY OF THE INVENTION

An object of the invention is to provide a rotor of the type mentioned initially which, while requiring little space for electromagnetically inactive insulation material, is distinguished by good resistance to mechanical and thermal stresses and good resistance to electrical voltages, and by problem-free cap mounting with a simplified design at the same time.

According to the present invention, a rotor is provided, which uses comparatively thin covering channels for insulation in the slots, which are formed with axially stepped ends at the ends of the rotor body, and uses an (integral) ring or a plurality of cap insulation segments as the cap insulation, which are formed toward the rotor body such that it or they fit onto the axially stepped ends of the covering channels, and over which the rotor cap is pushed directly.

This sort of cap insulation achieves the following advantages:
thin insulation in the radial direction;
good resistance to electrical voltages;
good stiffness in the radial direction;
a small number of components, and
adequate mechanical strength for cap mounting (shrinking-on)

In a preferred embodiment of the invention the cap insulation ring or the cap insulation segments have a thickness which is equal to or only insignificantly greater than the thickness of the covering channels.

In another preferred embodiment of the invention the cap insulation ring or the cap insulation segments are designed to have a thermal resistance to withstand the temperatures which occur while the rotor caps are being thermally shrunk onto the rotor body without adversely affecting their function.

When cap insulation segments are used, these are preferably guided tangentially by means of suitable fixing elements.

### BRIEF DESCRIPTION OF THE DRAWINGS

The invention will be explained in more detail in the following text using exemplary embodiments and in conjunction with the drawings, in which:

FIG. 1 shows a partially sectioned perspective illustration of one end of the rotor body with an adjacent rotor end winding and rotor cap of a rotor according to the prior art;

FIG. 2 shows a longitudinal section through the transition from an axially stepped thin covering channel to multilayer thin cap insulation, as has already been used in practice;

FIG. 3 shows an illustration comparable to that in FIG. 2 of the transition from an axially stepped thin covering channel to a radially stiff cap insulation element of the same thickness according to one preferred exemplary embodiment of the invention; and

FIG. 4 shows an illustration, comparable to that in FIG. 1, of a rotor according to one preferred exemplary embodiment of the invention.

### DETAILED DESCRIPTION

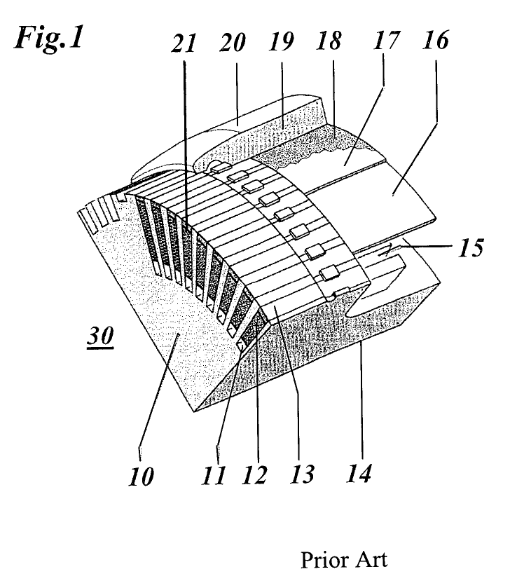

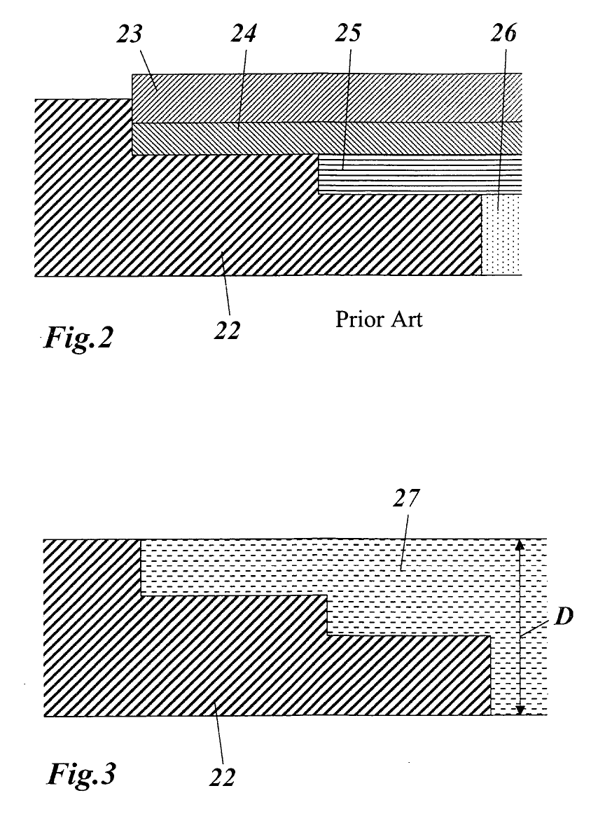

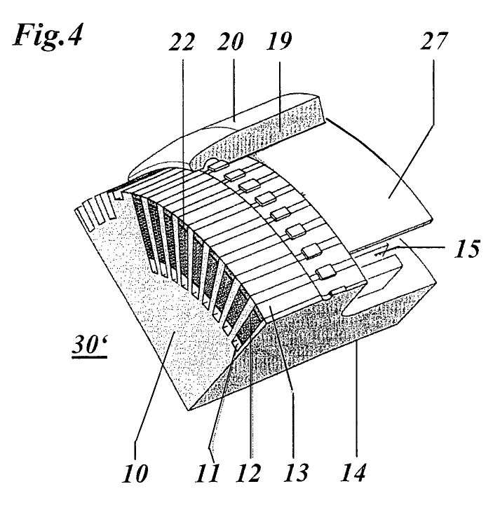

In an illustration comparable to that in FIG. 2, FIG. 3 shows the transition from an axially stepped covering channel 22 to a radially stiff cap insulation segment 27 of approximately the same thickness D according to one preferred exemplary embodiment of the invention. In an illustration comparable to that in FIG. 1, FIG. 4 shows a rotor 30′ according to one preferred exemplary embodiment of the invention. The cap insulation segments 27 which are adjacent in a stepped form to the covering channels 22 are in this case located directly, that is to say without any intermediate protective cap plates, under the cap ring 19 of the rotor cap 20. However, it is also possible to use an integral, slotted cap insulation ring instead of the cap insulation segments 27.

By way of example, the cap insulation segments 27 are in the form of half-shells, and are distinguished by the following features and advantages:

The cap insulation segments have high radial stiffness.

The cap insulation segments have high tangential stiffness.

The cap insulation segments are formed toward the rotor body in such a way that they fit onto axially stepped covering channels.

The strength of the cap insulation segments is designed such that they have the same thickness as the covering channels, or only an insignificantly greater thickness.

The thermal resistance of the cap insulation segments is designed such that they withstand the temperatures which occur during cap fitting and avoid the need for metallic cap plate segments. In general, fiber-reinforced plastics with resins that are resistant to high temperatures are used for this purpose. The long-term thermal strength complies with the thermal insulation class for the generator. It must be possible to withstand temperatures of about 350° C. without damage several times within a few hours for cap fitting and removal.

If required, the cap insulation segments can be reused after cap removal.

The cap insulation segments can be guided tangentially by suitable fixing elements (for example fingers in ventilation slots or pins in spacer blocks).

What is claimed is:

1. A rotor for a generator, the rotor comprising:
a rotor body having axial ends;
a plurality of slots running axially in the rotor body;
a plurality of conductor bars, each disposed in a respective one of the slots and electrically connected to each other at each axial end of the rotor body in a rotor end winding;
a plurality of wedges, each supporting a respective one of the conductor bars radially in the respective slot;
a plurality of electrically insulating covering channels, each disposed in a respective one of the slots between a respective uppermost conductor bar and a respective wedge, and being formed with axially stepped ends at the ends of the rotor body;
a rotor cap covering the rotor end winding at each axial end of the rotor body;
a cap insulation disposed between the rotor end winding and the rotor cap and connected to the plurality of covering channels outside the rotor body, the cap insulation including at least one of a ring and a plurality of cap insulation segments formed towards the rotor body so as to fit onto the axially stepped ends of the covering channels, the rotor cap being disposed directly adjacent to the cap insulation.

2. The rotor as recited in claim 1, wherein cap insulation includes a ring having a thickness equal to or only insignificantly greater than a thickness of the covering channels.

3. The rotor as recited in claim 1, wherein cap insulation includes a plurality of cap insulation segments having a thickness equal to or only insignificantly greater than a thickness of the covering channels.

4. The rotor as recited in one claim 1, wherein the cap insulation includes a ring having a thermal resistance adequate to withstand a temperature occurring while the rotor caps are being thermally shrunk onto the rotor body without an adverse affect on the function of the ring.

5. The rotor as recited in one claim 1, wherein the cap insulation includes a plurality of cap insulation segments having a thermal resistance adequate to withstand a temperature occurring while the rotor caps are being thermally shrunk onto the rotor body without an adverse affect on the function of the cap insulation segments.

6. The rotor as recited in claim 1, wherein the cap insulation include at least one fixing element configured to tangentially guide the cap insulation segments during installation.

7. The rotor as recited in claim 1, wherein the generator is a high-power turbogenerator.
